(19) United States
(12) Patent Application Publication
(10) Pub. No.: US 2026/0343199 A1
(43) Pub. Date: Oct. 29, 2026

(54) DATA TRANSMISSION BY SHORT RANGE DEVICE

(71) Applicant: QUALCOMM Incorporated, San Diego, CA (US)

(72) Inventors: Baya Reddy L N, Hyderabad (IN); Syam Pavan VADAPALLI, Visakhapatnam (IN)

(21) Appl. No.: 19/188,912

(22) Filed: Apr. 24, 2025

(51) Int. Cl. H04W 4/80; G06K 7/10; H04W 52/28

(52) U.S. Cl. CPC H04W 4/80; H04W 52/28; G06K 7/10297

(57) ABSTRACT

A method of wireless communication performed by a user equipment (UE) comprises setting one or more short-range (SR) communication parameters for short-range communication of the UE based on one or more wireless wide area network (WWAN) communication conditions, a power level of the UE, a WWAN communication mode of the UE, or any combination thereof, and communicating with one or more tags based on the one or more SR parameters.

### TECHNICAL FIELD

Aspects of the disclosure relate generally to wireless technologies.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), RF sensing, and other technical enhancements. These enhancements, as well as the use of higher frequency bands, enable improved RF sensing and 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a user equipment (UE) comprises: setting one or more short-range (SR) communication parameters for short-range communication of the UE based on: one or more wireless wide area network (WWAN) communication conditions; a power level of the UE; a WWAN communication mode of the UE; or any combination thereof; and communicating with one or more tags based on the one or more SR parameters.

In an aspect, a user equipment (UE) comprises: one or more memories; one or more transceivers; and one or more processors communicatively coupled to the one or more memories and the one or more transceivers, the one or more processors, either alone or in combination, configured to: set one or more short-range (SR) communication parameters for short-range communication of the UE based on: one or more wireless wide area network (WWAN) communication conditions; a power level of the UE; a WWAN communication mode of the UE; or any combination thereof; and communicate with one or more tags based on the one or more SR parameters.

In an aspect, a user equipment (UE) comprises: means for setting one or more short-range communication parameters for short-range (SR) communication of the UE based on: one or more wireless wide area network (WWAN) communication conditions; a power level of the UE; a WWAN communication mode of the UE; or any combination thereof; and means for communicating with one or more tags based on the one or more SR parameters.

In an aspect, a non-transitory computer-readable medium stores computer-executable instructions that, when executed by a user equipment (UE), cause the UE to: set one or more short-range (SR) communication parameters for short-range communication of the UE based on: one or more wireless wide area network (WWAN) communication conditions; a power level of the UE; a WWAN communication mode of the UE; or any combination thereof; and communicate with one or more tags based on the one or more SR parameters.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A and 3B are simplified block diagrams of several sample aspects of components that may be employed in a user equipment (UE) and a remote tag reader (RTR), respectively, and configured to support communications as taught herein.

FIG. 4A illustrates an example of a communication mode of an RTR.

FIG. 4B illustrates an example of a tag read operation.

FIG. 5A illustrates an example of a timing diagram demonstrating pulse interval encoding (PIE).

FIG. 5B illustrates example timing diagrams demonstrating the effect of Tari and Miller index (M) on pulse interval encoding (PIE).

FIG. 6 illustrates a call flow in which a UE performs WWAN operations and short-range (SR) communication, according to aspects of the disclosure.

FIG. 7 illustrates an example method of wireless communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to short-range (SR) communication. Some aspects more specifically relate to data transmission by a remote tag reader (RTR) or by a UE having RTR functionality. In some examples, a UE sets one or more SR communication parameters based on one or more wireless wide area network (WWAN) communication conditions, a power level of the UE, a WWAN communication mode of the UE, or any combination thereof.

Particular aspects of the subject matter described in this disclosure can be implemented to realize one or more of the following potential advantages. In some examples, by setting the one or more SR communication parameters based on the one or more WWAN communication conditions, the described techniques can be used to perform low-power SR operations at a time when resource demands associated with WWAN operations are high, and/or facilitate compliance with specific absorption rate (SAR) requirements by reducing transmission power associated with SR operations. In some examples, by setting the one or more SR communication parameters based on the power level of the UE, the described techniques can be used to perform low-power SR operations at a time when power conservation is prioritized (e.g., when a battery level of the UE is low). In some examples, by setting the one or more SR communication parameters based on the WWAN communication mode of the UE, the described techniques can be used to perform low-power SR operations at a time when resource demands associated with WWAN operations are high (WWAN connected mode), and/or perform high-power SR operations (e.g., a long-range tag read operation with high reliability) at a time when resource demands associated with WWAN operations are low (WWAN idle mode) and SR operations are less likely to be limited by specific absorption rate (SAR) requirements.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

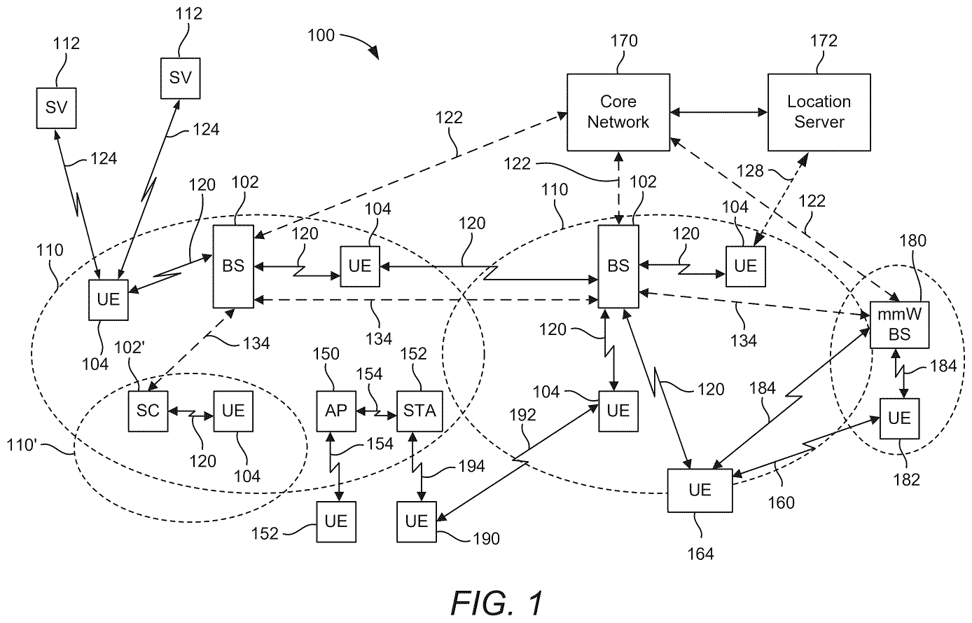

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on.

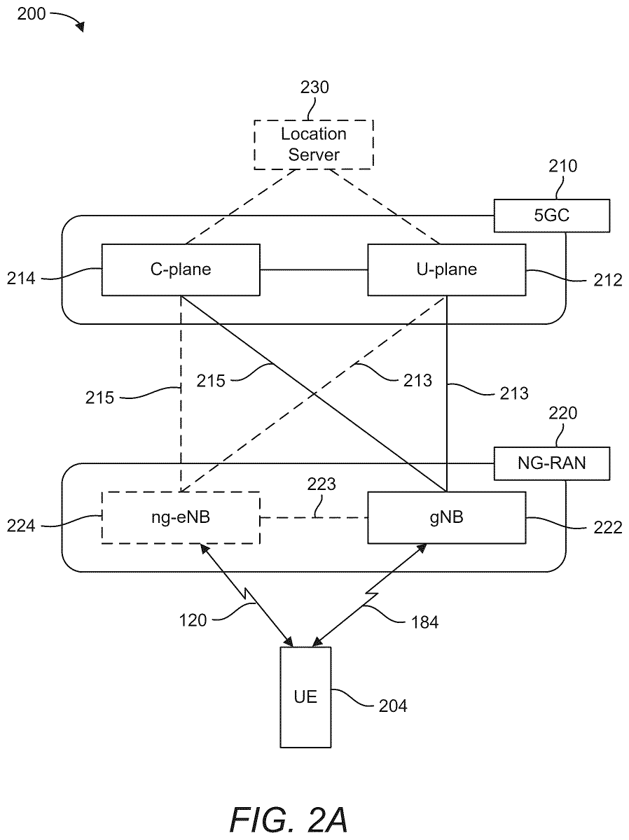

FIG. 2 illustrates an example of an electronic shelf label (ESL) (also known as electronic shopping label) communication network, according to aspects of the disclosure. In particular, FIG. 2 illustrates one possible implementation of an ESL system in a wireless network 200 configuration. One exemplary grouping of ESLs 220 is coupled to an AP 210. The AP helps manage and control the entire ESL system and all of the interconnected devices.

One or more network access points may be configured to communicate with one or more network entities via a wire-based or wireless backhaul connection 230. In some aspects, network interfaces may be implemented as transceivers configured to support wire-based or wireless signal communication. For example, this communication may involve sending and receiving messages, parameters, and/or other types of information content or data.

In some aspects, transceiver circuitry includes at least one transmitter and at least one receiver. This may include an integrated device containing both transmitter and associated transmitter circuitry and receiver and associated receiver circuitry on one monolithic or integrated device. They may also be separate and distinct devices or hybrid combinations of devices for a plurality of transmitter and receiver configurations.

In FIG. 2, the coupling shown (e.g. between an ESL 220 and the AP 210) is wireless and bidirectional, however other coupling methods such as hard wiring (or a hybrid combination of the two coupling methods or mechanisms working together) can be used, without deviating from the devices, methods, spirit and scope disclosed herein. The management entity (ME) 240 provides control and processing, as well as other functionality used to support and implement the ESL system. It can implement a supervisory or master role too within the communication network.

The following discusses some exemplary implementations of an ESL system. ESLs may be used to track and identify thousands, tens of thousands or any other number of product items for sale. It is often a business requirement or design goal to have an inventory of items, whose prices must be updated frequently, accurately and within minimum business disruption. The electronic display modules can be updated from a central control or management system by using wireless (or hard-wired or combination thereof) communications. Hard-wired systems have obvious problems in terms of the layout limitations caused by complicated cabling due to the high number of individual ESLs that are connected, as well as the widespread physical footprint or topology that encompasses all of the ESLs used in a given network.

Wireless ESL systems use individual power supplies (e.g. a battery) for each ESL. It is also advantageous for each ESL to have a long duration power supply lifetime (i.e. a long operational lifetime for the batteries before a replacement is warranted). Some of these batteries may last seven years or more. Some of these batteries are related to those that power quartz watches for a year or more. Those skilled in the art will also appreciate that, in addition to battery power, other power sources can be used, such as hard-wired power, energy harvesting and magnetic coupling as some examples.

In addition, the wireless systems need to be able to provide dependable communication channels in environments that have a high number of individual receiver-transmitter units and to operate with minimum transmitting power levels in order to prolong battery life.

There are times during operation, where the ESLs may lose connectivity, either momentarily or for more extended periods of time. Network outages, power outages, device failure and obstructions (both physical and non-physical) can cause these losses, as well as other events or situations. One desirable technical advantage or design goal is to facilitate reconnection of the ESLs, when this connectivity is lost or hindered in some manner. Some of the ESL design elements or considerations involved in supporting reconnection are as follows.

Selecting a suitable battery is one of them. The battery life is evaluated and selected so that it is not a limiting factor in the design of an ESL. For example, a battery life of around five years or more provides some advantages. The ESL typically contains a display (e.g. liquid crystal display (LCD), light emitting diode (LED), etc.).

In one representative example, a display possessing a latency of less than two seconds is advantageous. This tends to increase processing efficiencies, reduce system downtime, reduce power consumption, increase operational reliability and achieve other desirable design goals and objectives.

The ESLs may be moved, either by accident (e.g. a person or piece of equipment impacts the ESL) or deliberately (e.g. an employee moves the inventory stock around), and it may be advantageous to reconnect to a different AP quickly. The wireless connection to ESLs may be temporarily blocked by customers, trolleys/shopping carts or employees that are stacking the shelves. In this case, the ESL may lose connection and must figure out whether to reconnect to the same AP or try and move to a different AP, while minimizing power consumption, network disruption and latency. There may be computational and performance advantages to try and re-establish connections with the same AP that the ESLs were connected to, prior to losing previous connections. In one implementation, a method for an un-connected communication device (e.g. radio devices) is used to determine an approximate number of other un-connected communication devices that have lost contact with a host communication device.

It should be noted that an ESL and an Access Point may maintain synchronization without needing to establish a periodic connection. Instead, an Access Point may broadcast and an ESL may listen (at a point it time where the broadcast occurs, based on the knowledge of synchronization/schedule previously exchanged). At the start of the relationship between an AP and an ESL, an on-boarding process may occur occurred. This is achieved via a connection, which may then be closed when the information has been exchanged.

For purposes of this disclosure, one example of connected information devices is devices that can exchange information with each other. This exchange of information can be directional or bidirectional in nature. For instance, this may refer to a situation where given two devices (e.g. Device A and Device B), Device B is capable of receiving information from Device A, and conversely, Device A is also capable of receiving information from Device B. A non-connection (i.e. the state of being not connected) of these two devices occurs when Device B is no longer able to communicate with Device A. The term connectivity refers to the situation where information is being exchanged between at least two entities. A non-connection is when the two devices are not capable of communicating with each other.

There are many different situations where devices are communicating with each other (and therefore considered connected). A host device is sending out beacon signals to other individual devices that are connected via a communication network. As long as this beacon is being received at a device, there is a connection. This may be only one way communication, but this is the minimum connection that is needed to support operation. The present disclosure does not intend to limit connection to two way communications only. It can be unidirectional, bidirectional and any combinations thereof.

Various communication devices can receive information for establishing a link with an AP. Communication devices may link, or associate with an AP. For example, a communication device can send association requests to the AP. In one example, the association requests can be referred to generally as access requests. The AP can also respond with association responses. Generally, association responses can be referred to as access responses. Within a given network, there may be a large number of association requests. For example, where a large number of communication devices come within range of the AP, the AP may receive hundreds of association requests in a relatively short amount of time. In some situations, overlapping association messages can collide, ultimately increasing link setup time and latency, and decreasing overall network performance.

In some implementations, communication devices can be configured to delay transmission of association requests, thereby reducing the rate of collisions. For example, transmission time slots can be determined and a back-off amount within the identified time slot selected. By identifying a time slot during which to transmit the delayed association request, the requests can be spread over multiple time slots. Where the number of communication devices is greater than the number of available time slots, controlling when each device assigned to the same time slot transmits can improve efficiency.

An AP can schedule transmission of access responses (e.g., probe responses and/or association responses) during an access response window. For example, the AP can be configured to transmit access response messages during specified transmit windows. The access response window can be dynamic (e.g. based on the number of pending responses). In some implementations, the AP can also be configured to request a contention free period (e.g. clear-to-send) before transmitting the access response message. Accordingly, signal collisions can be reduced or practically eliminated.

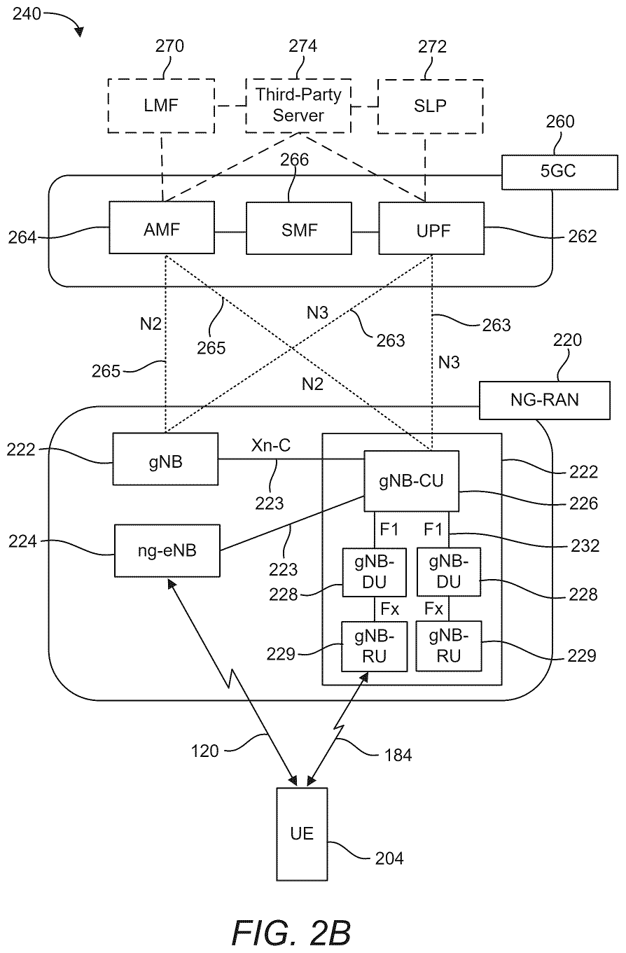

FIGS. 3A and 3B illustrate several example components (represented by corresponding blocks) that may be incorporated into a remote tag reader, according to aspects of the disclosure.

A remote tag reader (RTR) may include one or more antenna/radio devices associated with a low probability of interference with other antenna/radio services. For example, due to the short transmission range associated with the RTR, the RTR may transmit at low power (e.g., may not be capable of transmitting at high power). Any device that is capable of lower-power transmission may be considered as an RTR. For example, a UE (e.g., UE 302 illustrated in FIG. 3A) may be capable of operating as an RTR (e.g., may comprise an remote-reading antenna/radio associated with low-power transmission and/or other RTR functionality), but may also be capable of operating as a cellular device, wireless access point, etc. Other RTRs (e.g., RTR 304 illustrated in FIG. 3B) may not be capable of high-power transmission (e.g., due to hardware constraints). Examples of RTRs include radio frequency identification (RFID) devices (e.g., RFID readers, a UEs with RFID reader functionality, etc.). Other examples of RTRs include access control devices (e.g., door and gate openers), alarms and movement detectors, closed-circuit television (CCTV) systems, cordless audio devices (e.g., wireless microphones), local area networks (LANs), medical implants, remote control devices, road transport telematics, telemetry devices, etc.

UE 302 (which may correspond to any of the UEs described herein) and RTR 304 (which may correspond to any of the RTRs described herein) may be configured to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 includes one or more wireless wide area network (WWAN) transceivers 310, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The one or more WWAN transceivers 310 may each be connected to one or more antennas 316, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The one or more WWAN transceivers 310 may be variously configured for transmitting and encoding signals 318 (e.g., messages, indications, information, and so on), respectively, and, conversely, for receiving and decoding signals 318 (e.g., messages, indications, information, pilots, and so on), in accordance with the designated RAT. Specifically, the one or more WWAN transceivers 310 include one or more transmitters 314, for transmitting and encoding signals 318, and one or more receivers 312, for receiving and decoding signals 318.

The UE 302 includes, at least in some cases, one or more remote-reading wireless transceivers 320. The one or more remote-reading wireless transceivers 320 may be connected to one or more antennas 326, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The one or more remote-reading wireless transceivers 320 may be variously configured for transmitting and encoding signals 328 (e.g., messages, indications, information, and so on), and, conversely, for receiving and decoding signals 328 (e.g., messages, indications, information, pilots, and so on), in accordance with the designated RAT. Specifically, the one or more remote-reading wireless transceivers 320 include one or more transmitters 324, for transmitting and encoding signals 328, and one or more receivers 322, for receiving and decoding signals 328. As specific examples, the one or more remote-reading wireless transceivers 320 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 302 also includes, at least in some cases, one or more satellite signal interface 330, which includes one or more satellite signal receivers 332, and may optionally include one or more satellite signal transmitters 334.

The one or more satellite signal receivers 332 may be connected to one or more antennas 336, and may provide means for receiving and/or measuring satellite positioning/communication signals 338. Where the one or more satellite signal receivers 332 are satellite positioning system receivers, the satellite positioning/communication signals 338 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the one or more satellite signal receivers 332 are non-terrestrial network (NTN) receivers, the satellite positioning/communication signals 338 may be communication signals (e.g., carrying control and/or user data) originating from a 5G network. The one or more satellite signal receivers 332 may comprise any suitable hardware and/or software for receiving and processing satellite positioning/communication signals 338. The one or more satellite signal receivers 332 may request information and operations as appropriate from the other systems, and, at least in some cases, perform calculations to determine a location of the UE 302 using measurements obtained by any suitable satellite positioning system algorithm.

The optional satellite signal transmitter(s) 334, when present, may be connected to the one or more antennas 336, and may provide means for transmitting satellite positioning/communication signals 338. Where the satellite signal transmitter(s) 374 are satellite positioning system transmitters, the satellite positioning/communication signals 378 may be GPS signals, GLONASS® signals, Galileo signals, Beidou signals, NAVIC, QZSS signals, etc. Where the satellite signal transmitter(s) 334 are NTN transmitters, the satellite positioning/communication signals 338 may be communication signals (e.g., carrying control and/or user data) originating from a 5G network. The satellite signal transmitter(s) 334 may comprise any suitable hardware and/or software for transmitting satellite positioning/communication signals 338. The satellite signal transmitter(s) 334 may request information and operations as appropriate from the other systems.

The UE 302 and the RTR 304 each include one or more RTR transceivers 350 and 360, respectively, providing means for communicating (e.g., means for transmitting, means for receiving, etc.) with other network entities (e.g., other UEs, other RTRs, one or more transponders, one or more tags, etc.).

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, RTR 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, RTR 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., one or more WWAN transceivers 310, one or more remote-reading wireless transceivers 320) may also include a network listen module (NLM) or the like for performing various measurements.

As used herein, the various wireless transceivers and wired transceivers may generally be characterized as “a transceiver,” “at least one transceiver,” or “one or more transceivers.” As such, whether a particular transceiver is a wired or wireless transceiver may be inferred from the type of communication performed.

The UE 302 and RTR 304 also include other components that may be used in conjunction with the operations as disclosed herein. The UE 302 and RTR 304 include one or more processors 342 and 384, respectively, for providing functionality relating to, for example, wireless communication, and for providing other processing functionality. The processors 342 and 384 may therefore provide means for processing, such as means for determining, means for calculating, means for receiving, means for transmitting, means for indicating, etc. In an aspect, the processors 342 and 384 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302 and RTR 304 include memory circuitry implementing memories 340 and 386 (e.g., each including a memory device), respectively, for maintaining information (e.g., information indicative of reserved resources, thresholds, parameters, and so on). The memories 340 and 386 may therefore provide means for storing, means for retrieving, means for maintaining, etc. In some cases, the UE 302 and RTR 304 may include reading component 348 and 388, respectively. The reading component 348 and 388 may be hardware circuits that are part of or coupled to the processors 342 and 384, respectively, that, when executed, cause the UE 302 and RTR 304 to perform the functionality described herein. In other aspects, the reading component 348 and 388 may be external to the processors 342 and 384 (e.g., part of a modem processing system, integrated with another processing system, etc.). Alternatively, the reading component 348 and 388 may be memory modules stored in the memories 340 and 386, respectively, that, when executed by the processors 342 and 384 (or a modem processing system, another processing system, etc.), cause the UE 302 and RTR 304 to perform the functionality described herein. FIG. 3A illustrates possible locations of the reading component 348, which may be, for example, part of the one or more RTR transceivers 350, the memory 340, the one or more processors 342, or any combination thereof, or may be a standalone component. FIG. 3B illustrates possible locations of the reading component 388, which may be, for example, part of the one or more RTR transceivers 360, the memory 386, the one or more processors 384, or any combination thereof, or may be a standalone component.

The UE 302 and RTR 304 may include one or more sensors 344 and one or more sensors 380, respectively, coupled to the one or more processors 342 and one or more processors 384, respectively, to provide means for sensing or detecting movement and/or orientation information that is independent of motion data derived from signals received by the one or more WWAN transceivers 310, the one or more remote-reading wireless transceivers 320, satellite signal interface 330, and/or RTR transceivers 350. By way of example, the one or more sensors 344 and one or more sensors 380 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the one or more sensors 344 and one or more sensors 380 may include a plurality of different types of devices and combine their outputs in order to provide motion information. For example, the one or more sensors 344 and one or more sensors 380 may use a combination of a multi-axis accelerometer and orientation sensors to provide the ability to compute positions in two-dimensional (2D) and/or three-dimensional (3D) coordinate systems.

In addition, the UE 302 and RTR may include a user interface 346 and user interface 347, respectively, providing means for providing indications (e.g., audible and/or visual indications) to a user and/or for receiving user input (e.g., upon user actuation of a sensing device such a keypad, a touch screen, a microphone, and so on).

At the UE 302, the receiver 312 receives a signal through its respective antenna(s) 316. The receiver 312 recovers information modulated onto an RF carrier and provides the information to the one or more processors 342. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by, for example, a base station. These soft decisions may be based on channel estimates computed by a channel estimator. The soft decisions are then decoded and de-interleaved to recover the data and control signals that were originally transmitted by a base station on the physical channel. The data and control signals are then provided to the one or more processors 342, which implements Layer-3 (L3) and Layer-2 (L2) functionality.

In the downlink, the one or more processors 342 provides demultiplexing between transport and logical channels, packet reassembly, deciphering, header decompression, and control signal processing to recover IP packets from the core network. The one or more processors 342 are also responsible for error detection.

Similar to the functionality described in connection with the downlink transmission by a base station, the one or more processors 342 provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

For convenience, the UE 302 and RTR 304 are shown in FIGS. 3A and 3B as including various components that may be configured according to the various examples described herein. It will be appreciated, however, that the illustrated components may have different functionality in different designs. In particular, various components in FIGS. 3A to 3B are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi and/or BLUETOOTH® capability without cellular capability), or may omit the remote-reading wireless transceiver(s) 320 (e.g., cellular-only, etc.), or may omit the satellite signal interface 330, or may omit the sensor(s) 344, and so on. For brevity, illustration of the various alternative configurations is not provided herein, but would be readily understandable to one skilled in the art.

The various components of the UE 302 and RTR 304 may be communicatively coupled to each other over data buses 308 and 382, respectively. In an aspect, the data buses 308 and 382 may form, or be part of, a communication interface of the UE 302 and RTR 304, respectively. For example, where different logical entities are embodied in the same device (e.g., gNB and location server functionality incorporated into the same RTR 304), the data buses 308 and 382 may provide communication between them.

The components of FIGS. 3A and 3B may be implemented in various ways. In some implementations, the components of FIGS. 3A and 3B may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 356 may be implemented by processor and memory component(s) of the UE 302 (e.g., by execution of appropriate code and/or by appropriate configuration of processor components). Similarly, some or all of the functionality represented by blocks 360 to 388 may be implemented by processor and memory component(s) of the RTR 304 (e.g., by execution of appropriate code and/or by appropriate configuration of processor components). For simplicity, various operations, acts, and/or functions are described herein as being performed “by a UE,” “by an RTR,” etc. However, as will be appreciated, such operations, acts, and/or functions may actually be performed by specific components or combinations of components of the UE 302, RTR 304, etc., such as the processors 342, 384, the transceivers 310, 320, 330, 350, and 360, the memories 340 and 386, the reading component 348 and 388, etc.

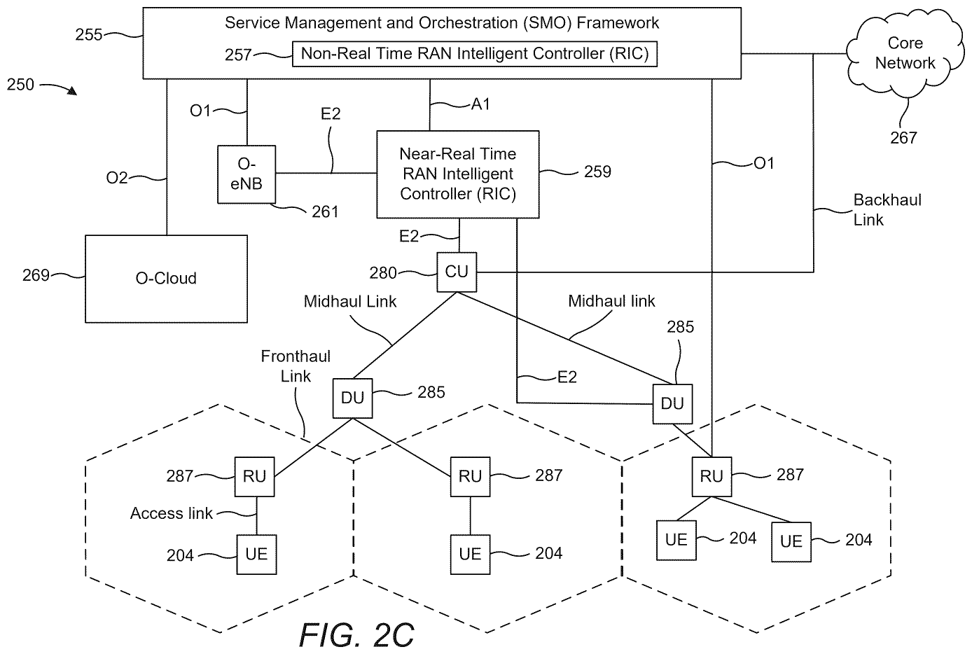

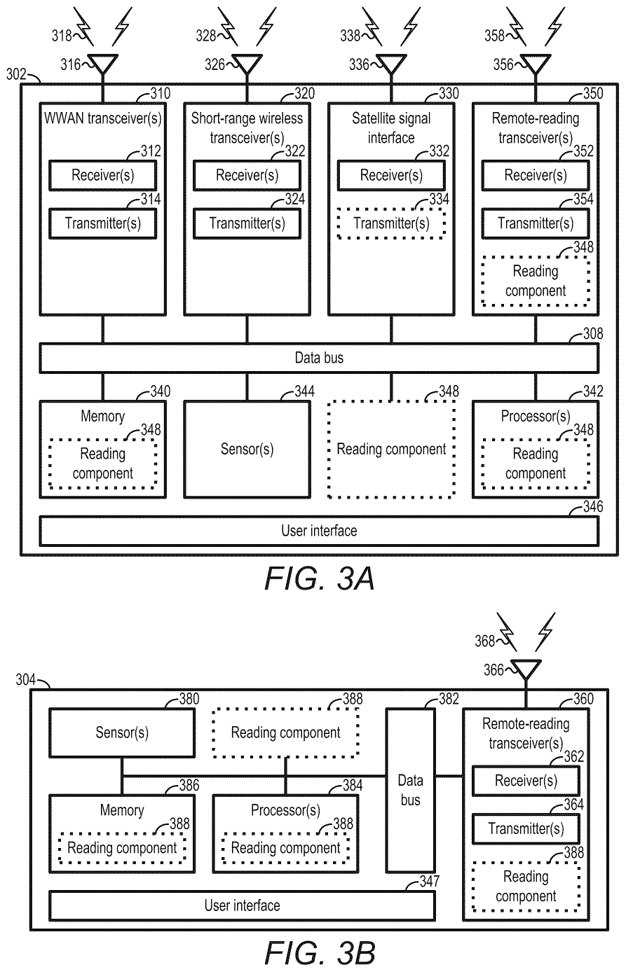

FIG. 4A illustrates an example of a communication mode of an RTR. The communication scenario may be a short-range communication scenario associated with an RTR and one or more transponders or tags. In the example, the communication scenario involves a UE or RTR, illustrated as an RFID reader 401. It will be understood that the functionality of the RFID reader 401 may be implemented in any of the UEs and/or RTRs described herein (e.g., the UE 302 and/or RTR 304 described previously). The RFID reader 401 may communicate with the one or more transponders or tags, illustrated as an RFID tag 421, an RFID tag 422, and an RFID tag 423.

In an example, the RFID tags 421, 422, 423 are passive RFID tags which use received energy of a forward link transmission (e.g., transmitted by RFID reader 401) to generate a reverse link transmission (e.g., backscatter). Other types of RFID tags exist, including active RFID tags, which have a dedicated power source to support the reverse link transmission, and semi-passive RFID tags, which have a dedicated power source to assist with the reverse link transmission. The techniques described in the present disclosure may be implemented with any type of tag.

In the example of FIG. 4A, RFID reader 401 transmits (e.g., broadcasts) via the forward link. The range of the forward link transmission may depend on the transmission power of the forward link transmission. The left-hand side of FIG. 4A corresponds to low-power transmissions and the right-hand side corresponds to high-power transmissions (i.e., higher-power transmissions than the transmissions illustrated at left). The low-power transmissions have a forward link range 411 and the high-power transmissions have a forward link range 412. The forward link ranges 411, 412 are represented as shaded circles. It will be understood that the forward link range 412 is larger than the forward link range 411 by virtue of the higher transmission power associated with the forward link range 412. The extent of the forward link ranges 411, 412 may be affected by other factors, for example, tag sensitivity.

An RFID tag that is within the range of the forward link may be configured to transmit a reply via the reverse link. In the case of a passive tag, the RFID reader 401 may provide the energy that is used to transmit the reply. For example, to detect a reply from RFID tag 421 (e.g., receive a reverse link transmission from RFID tag 421), the RFID reader 401 may transmit via the forward link with transmission power in excess of what is necessary to merely reach RFID tag 421. Upon reaching RFID tag 421, the power of the transmitted signal may be diminished, but the remaining power may still be sufficient to enable RFID tag 421 to transmit a reply that reaches RFID reader 401.

Accordingly, the transmission power of the forward link is a factor for determining the range at which RFID reader 401 can reliably detect a reply from RFID tags 421, 422, 423, etc. In the example of FIG. 4A, a reply from a tag may be received if the tag is within the forward link range (e.g., forward link range 411 or forward link range 412, depending on the transmission power).

Whether RFID reader 401 receives a reply from a tag also depends on the range of the reverse link transmission. Even if a transmission in the forward link reaches the tag, the reply will not be received unless the reverse link reaches RFID reader 401. As noted above, the transmission power in the forward link (and the distance between the tag and the reader) may impact the range of the reverse link. As will be discussed in greater detail below, the range of the reverse link may be affected by a communication mode of the tag. In some implementations, the communication mode may be referred to as a radio frequency (RF) mode. The communication mode of the tag may be characterized by a Miller index (M). The Miller index M may correspond to a number of subcarrier cycles per symbol, as will be discussed in greater detail below.

In FIG. 4A, several reverse links are illustrated, each corresponding to a different communication mode. The extent of each reverse link is illustrated as an unshaded circle with a dashed line. Each illustration contains three dashed circles with three different radiuses, representing reverse links with different ranges. The different ranges correspond to different communication modes of the tag. In FIG. 4A, the different communication modes of the tag correspond to different values of M (e.g., with other factors held constant). As will be discussed in greater detail below, the range of the reverse link may increase as M increases.

In an example, RFID reader 401 performs a read and/or inventory operation involving one or more tags. Whether the RFID reader 401 reads (for example) RFID tag 422 may depend on (1) whether the forward link transmission reaches RFID tag 422 and (2) whether the reply of RFID tag 422 reaches RFID reader 401. As per the illustrated example, the RFID reader 401 may read RFID tag 422 if (1) RFID tag 422 is within the shaded circle representing the range of the forward link and (2) RFID tag 422 is within the dashed circle representing the range of the reverse link. If RFID tag 422 is within both circles, then RFID reader 401 may read RFID tag 422.

As noted above, FIG. 4A illustrates different communication modes corresponding to different values of M. When a higher number of subcarrier cycles per symbol is used, a transmission duration per data bit is increased relative to a lower number of subcarrier cycles per symbol. As a result, the transmission is less susceptible to noise, because the bit sequence may still be effectively communicated.

As shown in FIG. 4A, various detection ranges associated with various values of M, denoted as Mₓ, M_{y}, and M_{z}. The detection ranges are illustrated as dashed lines. In the illustrated example, Mₓ<M_{y}<M_{z}. In an example, Mₓ=1, M_{y}=2, and M_{z}=4. For a low-power scenario (left), Mₓ is barely sufficient to reliably detect RFID tag 421. Increasing from Mₓ to M_{y} increases the detection range to easily include RFID tag 421, but RFID tag 422 is still beyond detection. Further increasing from M_{y} to M_{z} is sufficient to reliably detect RFID tag 421 and RFID tag 422, but RFID tag 423 is still beyond detection. In the high-power scenario (right), Mₓ only detects RFID tag 421; M_{y} detects RFID tag 421 and RFID tag 422; and M_{z} suffices to reliably detect all of the RFID tags 421, 422, 423.

FIG. 4B illustrates an example of a tag read operation 450, according to aspects of the disclosure. The tag read operation 450 may involve an interrogator and one or more tags. The interrogator may correspond to any of the UEs and/or RTRs described in the present disclosure (e.g., the UE 302, the RTR 304, the RFID reader 401, etc.). The one or more tags may correspond to any of the tags and/or transponders described in the present disclosure (e.g., the RFID tags 421, 422, 423, etc.).

The tag read operation 450 may follow a particular protocol (e.g., an RFID protocol). The protocol may prescribe, for example, a sequence of particular messages, the type of message to be sent in response to a particular message, the timing for responding to the particular message, etc. The tag read operation 450 illustrated in FIG. 4B corresponds to a particular protocol, although it will be understood that the present disclosure may be implemented in other contexts (e.g., different message sequences, different timings, etc.).

During the tag read operation 450, the interrogator may transmit a continuous wave 460. In an example, the continuous wave 460 may be transmitted throughout the tag read operation 450, and may be used by one or more tags which receive continuous wave 460 as a power and/or energy source. The one or more tags may use the power and/or energy supplied by continuous wave 460 to transmit one or more replies to the interrogator (e.g., backscatter). In an example, the interrogator may superimpose one or more messages on top of the continuous wave 460.

The tag read operation 450 may involve one or more tag read sequences. The one or more tag read sequences may be referred to as an inventory round. In an example, a first tag read sequence 451 corresponds to a first tag, and each subsequent tag read sequence may correspond to a different tag. FIG. 4B illustrates a first subsequent tag read sequence 452 which may correspond to, for example, a second tag. Other subsequent tag read sequences (e.g., a second subsequent tag read sequence having the same structure) may follow the first subsequent tag read sequence 452.

The first tag read sequence 451 may include transmission, by the interrogator, of a select message 471 and a query message 472. The first tag read sequence 451 may begin with transmission of the continuous wave 460. In some implementations, the select message 471 may not be transmitted until continuous wave 460 has been transmitted for a certain amount of time. For example, a protocol of the tag read operation 450 may prescribe that the interrogator transmits continuous wave 460 for at least one and one-half milliseconds (1.5 ms) before transmitting select message 471. The transmission of continuous wave 460 may support pre-charging of one or more tags (e.g., one or more passive tags). Additionally or alternatively, the protocol may prescribe an amount of time T4 between transmission of select message 471 and query message 472. In the illustrated example, after transmission of select message 471 is complete, the interrogator waits for T4 to elapse before beginning to transmit query message 472.

The select message 471 may indicate one or more tags that are selected for the tag read operation 450. As an example, the interrogator may select a tag population (e.g., one or more particular tags) for reading and/or inventory, and select message 471 may comprise or consist of a select command. As another example, the interrogator may select a tag population for cryptographical challenge and/or authentication, and select message 471 may comprise a challenge command. As an example, to indicate which tags are selected, select message 471 may indicate a file type. A tag that receives select message 471 may determine whether it stores a file having the indicated file type. If the indicated file type is stored by the tag, then the tag determines that it has been selected by the interrogator. As another example, select message 471 may comprise a bit sequence (e.g., in a mask field) and may indicate a location in memory (e.g., in pointer and length fields). A tag that receives select message 471 may determine whether the bit sequence in the select message 471 matches the tag's memory at the indicated location. If there is a match, then the tag determines that it has been selected by the interrogator.

The query message 472 may, for example, initiate and/or specify an inventory round and/or a session associated with the inventory round. The inventory round (and/or session thereof) may comprise one or more tag read sequences. The inventory round may involve the one or more tags indicated by select message 471. The query message 472 may indicate (e.g., comprise a value indicating) the inventory round and/or session. The query message 472 may indicate a subset of the one or more tags indicated by 471. The query message 472 may indicate (e.g., comprise a value indicating) a slot count parameter (Q). The query message 472 may indicate (e.g., comprise a value indicating) a number of subcarrier cycles per symbol (M), a backscatter link frequency (BLF), or any combination thereof (e.g., a communication mode).

Each tag that receives query message 472 may select a random number. The random number may indicate a slot for communicating (or attempting to communicate) with the interrogator. The random number may function as a slot counter. As an example, a first tag may generate a first random number indicating to attempt communication with the interrogator in a first slot (e.g., during the first tag read sequence 451). One or more other tags (e.g., a second tag, a third tag, etc.) may generate other random numbers indicating to remain silent during the first slot and/or attempt communication in a later slot.

The number of bits of the random number may be indicated by the slot count parameter (Q). The random number may have sixteen or fewer bits (e.g., four bits). Each tag may load a respective random number into the tag's slot counter. The tag may enter a ‘reply’ state and/or attempt to communicate during first tag read sequence 451 if the generated number is zero (e.g., 0000). Any tag which generates a non-zero number (e.g., 0001 or 0010) may enter an ‘arbitrate’ state and/or remain silent during first tag read sequence 451.

The first tag (e.g., the tag that generates a particular random number, or is selected by some other technique) may respond to query message 472 by transmitting a random number message 481. The random number message 481 may comprise a random number generated by the first tag (e.g., the random number used loaded to the slot counter or a new random number). The random number may be, for example, sixteen bits (e.g., RN16). The protocol associated with tag read operation 450 may prescribe an amount of time T1 between reception of query message 472 and transmission of random number message 481. In the illustrated example, after reception of query message 472 is complete, the first tag waits for T1 to elapse before beginning to transmit query message 472. In some implementations, a reply that is sent after waiting for T1 to elapse may be considered as an immediate reply.

After receiving random number message 481, the interrogator may transmit an acknowledgement message 482. The acknowledgement message 482 may indicate, for example, the same random number that is indicated by random number message 481. The protocol associated with tag read operation 450 may prescribe an amount of time T2 between reception of random number message 481 and transmission of acknowledgement message 482. In the illustrated example, after reception of random number message 481 is complete, the interrogator waits for T2 to elapse before beginning to transmit acknowledgement message 482.

After receiving the acknowledgement message 482, the tag that transmitted the random number message 481 (e.g., the first tag) may respond by transmitting an EPC message 483 indicating the tag's electronic product code (EPC). Before transmitting EPC message 483, the first tag may wait for T1 to elapse. Upon reception of EPC message 483, the interrogator has obtained the EPC of the first tag and may be considered as having successfully read and/or inventoried the first tag.

After receiving EPC message 483, the interrogator may transmit a query repeat message 484. The query repeat message 484 may indicate, for example, the inventory round or session (e.g., using the same value that was indicated in query message 472). The actions described below (as being performed by the tags in response to the query repeat message 484) may be performed based on the query repeat message 484 indicating the same inventory round and/or session as the query message 472.

Upon reception of query repeat message 484, the first tag may consider itself as having been successfully read and/or inventoried. For example, the first tag may exit the ‘acknowledged’ state, enter a ‘ready’ state, and/or set an ‘inventoried’ flag.

Other tags which receive the query repeat message 484 (e.g., the second tag and third tag) may decrement their respective slot counters (e.g., the second tag may decrement from 0001 to 0000 and the third tag may decrement from 0010 to 0001). Any tag with a slot counter equal to zero (e.g., the second tag) may exit the ‘arbitrate’ state and/or enter the ‘reply’ state. Any tag with a slot counter that is still non-zero (e.g., the third tag) may remain in the ‘arbitrate’ state and/or not enter the ‘reply’ state.

The first subsequent tag read sequence 452 may involve a non-inventoried tag and/or the tag that enters the ‘reply’ state (e.g., the second tag). The first subsequent tag read sequence 452 may follow a similar structure as the tag-specific portion of the first tag read sequence 451. The similar structure may involve similar messages and similar timings.

The second tag may transmit a random number message 491 (e.g., analogous to random number message 481). The random number message 491 may be transmitted based on the second tag being in a ‘reply’ state and/or the slot counter of the second tag (e.g., the slot counter being equal to zero). The random number message 491 may be transmitted in response to reception of query repeat message 484 (e.g., after time T1 has elapsed from reception of query repeat message 484).

The interrogator may transmit an acknowledgement message 492 (e.g., analogous to acknowledgement message 482). The acknowledgement message 492 may comprise the same random number as was included in the random number message 491. The acknowledgement message 492 may be transmitted in response to reception of query repeat message random number message 491 (e.g., after time T2 has elapsed from reception of random number message 491).

The second tag may transmit an EPC message 493 (e.g., analogous to EPC message 483). The EPC message 493 may be transmitted in response to reception of acknowledgement message 492 (e.g., after time T1 has elapsed from reception of random number message 491).

The interrogator may consider the second tag as having been inventoried based on reception of the EPC message 493. The interrogator may transmit a query repeat message 494 (e.g., analogous to query repeat message 484). The query repeat message 484 may be transmitted in response to reception of EPC message 493 (e.g., after time T2 has elapsed from reception of EPC message 493).

Upon reception of query repeat message 494, the second tag (e.g., the tag in the ‘acknowledged’ state) may consider itself as having been successfully read and/or inventoried. For example, the first tag may exit the ‘reply’ state, enter an ‘acknowledged’ state, and/or set an ‘inventoried’ flag.

Other tags which receive the query repeat message 494 (e.g., the third tag) may decrement their respective slot counters (e.g., the third tag may decrement from 0001 to 0000). Any tag with a slot counter equal to zero (e.g., the third tag) may exit the ‘arbitrate’ state and/or enter the ‘reply’ state. Accordingly, another subsequent tag read sequence similar to first subsequent tag read sequence 452 may commence (not illustrated in FIG. 4). The next subsequent tag read sequence may involve the third tag. Further subsequent tag read sequences may commence in the same manner until, for example, the inventory round and/or session is over.

Generally, the tag read operation 450 described above may be described as having an initial round-specific or session-specific messaging sequence (corresponding to select message 471 in the illustrated example), followed by one or more tag-specific messaging sequences corresponding to the first tag (query message 472 through EPC message 483) and (optionally) additional tag-specific durations corresponding to additional tags (query repeat message 484 through EPC message 493).

In an example, a single-tag read sequence may have a duration between one and two-tenths of a millisecond (1.2 ms) and fifty milliseconds (50 ms), not including a pre-charge duration that may last at least one and one-half of a millisecond (1.5 ms). In a multi-tag read sequence, each additional tag read sequence may have a duration between one and two-tenths of a millisecond (0.5 ms) to forty-one milliseconds (41 ms). The variation may be due to various factors, including selection of the communication mode. For example, if the number of subcarrier cycles per symbol (M) is raised and/or the backscatter link frequency (BLF) is reduced, then each message (e.g., random number message 481, acknowledgement message 482, etc.) may take longer to transmit. Moreover, the pre-charge duration and the time between messages (the values of T4, T1, T2, etc.) may be based on elements of the communication mode. For example, the pre-charge duration may be equal the reciprocal of BLF (1/BLF) and T2 may be equal to twenty times the reciprocal of BLF (20/BLF).

The tag read operation 450 described above may correspond to an RFID protocol (e.g., an RFID air protocol). Ultra-high frequency (UHF) RFID may operate in a sub-GHz bandwidth (860-930 MHz). This bandwidth may be unlicensed spectrum and/or may be associated with regulations that limit transmission power (and thereby limit range). A reader that operates in accordance with RFID protocol may be considered as a remote tag reader (RTR).

UHF RFID has various use cases. For example, in a warehouse inventory and/or stock management scenario, ranges of two meters or more may be utilized. As another example, return and/or checkout services may use a range on the order of five centimeters. Generally, the RFID air protocol may define communication by a single reader (e.g., RFID reader 401) with multiple tags (e.g., passive tags such as RFID tags 421, 422, 423). The reader may extract product serial numbers (e.g., EPC as in the example of tag read operation 450) or may perform read/write operations to the tags.

The reader may include at least one antenna configured to operate at short range (e.g., within the prescribed bandwidth and/or below the maximum transmission power associated with that bandwidth). The reader may be a dedicated RTR (e.g., analogous to the RTR 304 illustrated in FIG. 3B). Commercially-available RTRs are often provided in a gun-shaped form factor. Additionally or alternatively, the reader may be a UE with an RTR capability (e.g., analogous to the UE 302 illustrated in FIG. 3A). The RTR capability may be provided by, for example, at least one RTR antenna configured to operate at short range, within the prescribed bandwidth, and/or below the maximum transmission power associated with that bandwidth. The RTR capability may also include other functionality related to the at least one RTR antenna. The RTR capability may be built into the UE (e.g., the at least one RTR antenna may be included in the UE along with one or more WAN antennas, one or more WLAN antennas, one or more Bluetooth antennas, one or more GNSS antennas, or any combination thereof). Additionally or alternatively, the RTR capability may be built into a separate device configured to be attached to the UE.

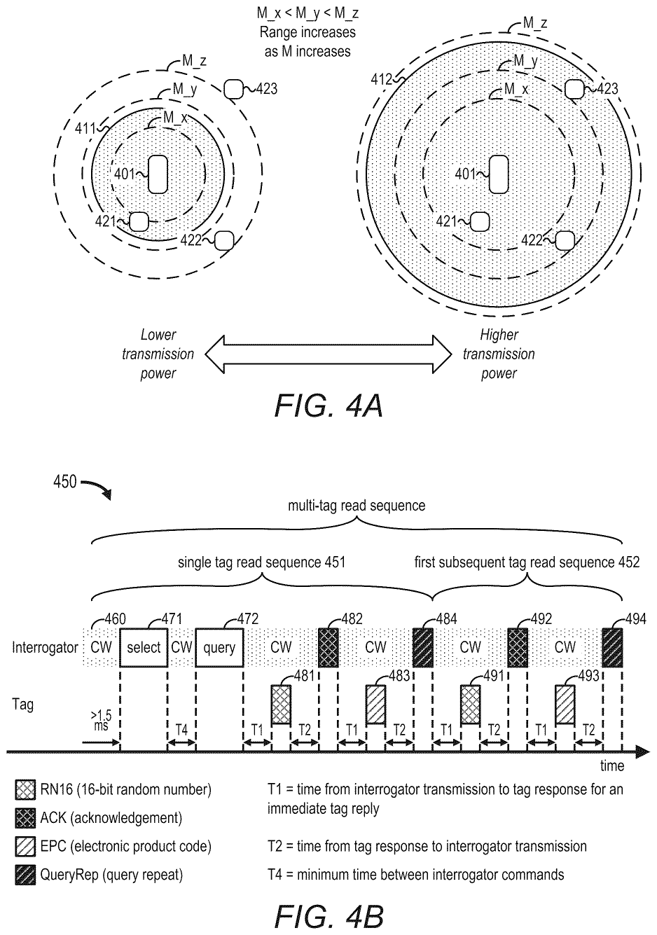

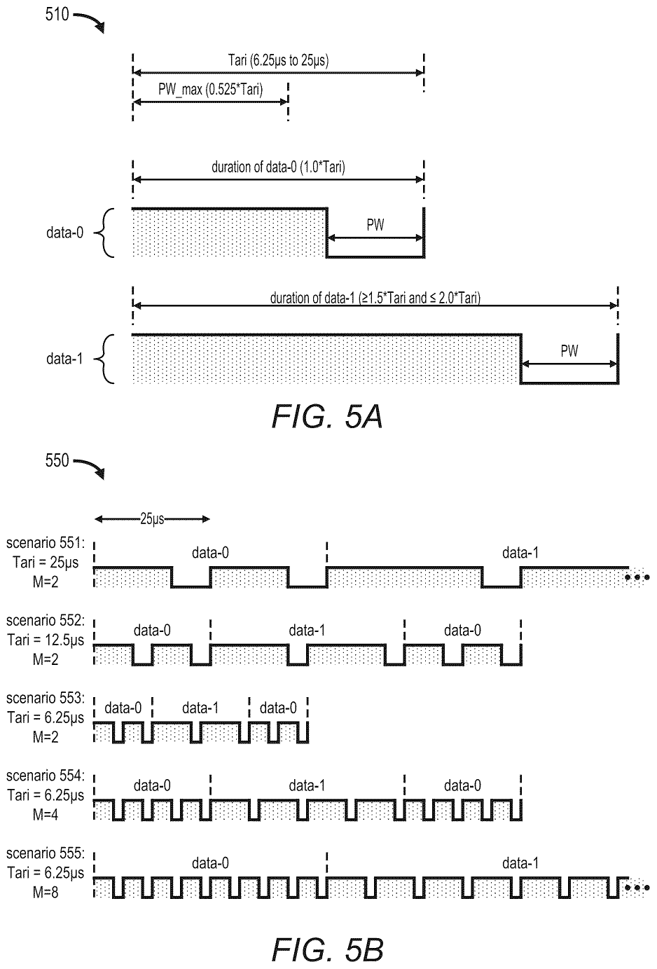

FIG. 5A illustrates an example of a timing diagram 510 demonstrating pulse interval encoding (PIE). PIE is a technique for encoding ones (data-1) and zeroes (data-0) in a wireless signal. PIE may be used to encode data in short-range transmissions from a reader and/or interrogator to a tag and/or transponder (e.g., using the one or more RTR transceivers 350 and/or one or more RTR transceivers 350 described above).

As may be observed from FIG. 5A, data-0 has a different duration than data-1. The durations of data-0 and data-1 may be related to a reference time interval referred to as Tari. The mnemonic “Tari” derives from the acronym TARI (Type A Reference Interval), which is used is certain specific contexts. In the present disclosure, Tari may refer to reference time intervals generally (including TARI).

In the context of the present disclosure, Tari is a short-range (SR) communication parameter that may be used to set and/or communicate the durations of data-0 and data-1 in the context of PIE. For example, the duration of data-0 may be equal to Tari (i.e., duration of data-0=1.0*Tari). By contrast, the duration of data-1 may be greater-than-or-equal-to one-and-one-half Tari and less-than-or-equal-to two Tari (i.e., 1.5*Tari≤duration of data-1≤2.0*Tari).

The data-0 and data-1 sequences both end with a pulse having a pulse width (PW). The PW of the pulse may vary, and may be defined relative to Tari. For example, Tari may be selected from values ranging from 6.25 μs to 25 μs, and the maximum pulse width (PW_max) may be a fraction of Tari (e.g., 0.525*Tari).

The data-0 and data-1 sequences may include a high value and a low value. The high value may correspond, for example, to the amplitude of a continuous wave analogous to the continuous wave 460 described above. The low value may correspond to an attenuation of the high value.

In the example of FIG. 5A, the data-0 sequence begins with transmission of a high value for a duration that is less than Tari, and is followed by a pulse, having a set pulse width, at the low value. The data-1 sequence begins with transmission of a high value for a duration that is greater than Tari, and is followed by a pulse, having a set pulse width (e.g., the same as the pulse width used for the data-0 sequence), at the low value.

FIG. 5B illustrates examples timing diagrams 550 demonstrating the effect of Tari and Miller index (M) on pulse interval encoding (PIE). The timing diagrams 550 show transmission of the bit sequence ‘010’ using different values of Tari and M.

The Miller index (M) may refer to a number of subcarrier cycles per symbol. Additionally or alternatively, M may indicate a number of signal transitions that are used to represent a single bit of information. For example, if M=2, then the data-0 sequence described above (which includes one signal transition) is repeated twice (two signal transitions to represent a single bit); if M=4, then the data-0 sequence described above is repeated four times (four signal transitions to represent a single bit); if M=8, then the data-0 sequence described above is repeated eight times; etc.

In a scenario 551, Tari is set at a high value (25 μs) and M is set at a low value (2). Because Tari is set to 25 μs, the duration of a single data-0 sequence is 25 μs. In the present example, a single data-1 sequence has a duration of 42 μs (an arbitrary length between 1.5*Tari and 2.0*Tari, selected for the sake of illustration). To communicate the first bit of the bit sequence ‘010’ with M=2, two data-0 sequences are transmitted (a total duration of 50 μs). To communicate the second bit of the bit sequence ‘010’ with M=2, two data-1 sequences are transmitted (a total duration of 84 μs). To communicate the third bit of the bit sequence ‘010’ with M=2, two data-1 sequences are transmitted. Due to space constraints, only a portion of the ‘010’ bit sequence is illustrated in FIG. 5B.

In a scenario 552, Tari is reduced to a middle value (12.5 μs) and M is held constant at M=2. Because M=2, two data- 0 sequences with a total duration of 25 μs (12.5 μs each) are transmitted, followed by two data-1 sequences with a total duration of 42 μs, and two more data-0 sequences with a total duration of 25 μs. It will be observed that the bit sequence ‘010’ can be transmitted in a shorter duration relative to the scenario 551, due to the halving of Tari.

In a scenario 553, Tari is halved again, in particular, set at a low value (6.25 μs), and M is held constant at M=2. Because M=2, two data- 0 sequences with a total duration of 12.5 μs (6.25 μs each) are transmitted, followed by two data-1 sequences with a total duration of 21 μs, and two more data-0 sequences with a total duration of 12.5 μs. It will be observed that the bit sequence ‘010’ can be transmitted in a shorter duration (46 μs) relative to the scenario 552 (92 μs) and the scenario 552 (184 μs).

In a scenario 554, Tari remains at the low value (6.25 μs) and M is increased to a middle value (4). Because M=4, four data-0 sequences are transmitted in order to encode the first bit in the bit sequence ‘010’. It will be understood that this doubles the amount of time needed to transmit each bit, relative to scenario 553 (25 μs relative to 12.5 μs for data-0; 42 μs relative to 21 μs for data-1).

In a scenario 555, Tari remains at the low value (6.25 μs) and M is increased to a high value (8). Because M=8, eight data-0 sequences are transmitted in order to encode the first bit in the bit sequence ‘010’. It will be understood that this doubles the amount of time needed to transmit each bit, relative to scenario 552 (50 μs relative to 25 μs for data-0; 84 μs relative to 42 μs for data-1). Similar to scenario 551, the entire ‘010’ bit sequence is not illustrated in FIG. 5B due to space constraints.

Based on the five scenarios presented in FIG. 5B, it will be understood that a transmitter may increase the data rate by decreasing the Tari value, decreasing the M value, or decreasing both. It will be further understood that because bit sequences can be transmitted more quickly by decreasing these values, less power is consumed by the transmission operation, and a user of the transmitter is exposed to less specific absorption (resulting in a lowering specific absorption rate (SAR)). On the other hand, when Tari and/or M are decreased, the reliability and/or range of communications may also be reduced. For example, a short burst of noise may obscure a short pattern, and have less of an impact on a long pattern. Accordingly, by increasing the Tari value, increasing the M value, or increasing both, the transmitter can cut through noise, thereby increasing range and reliability.

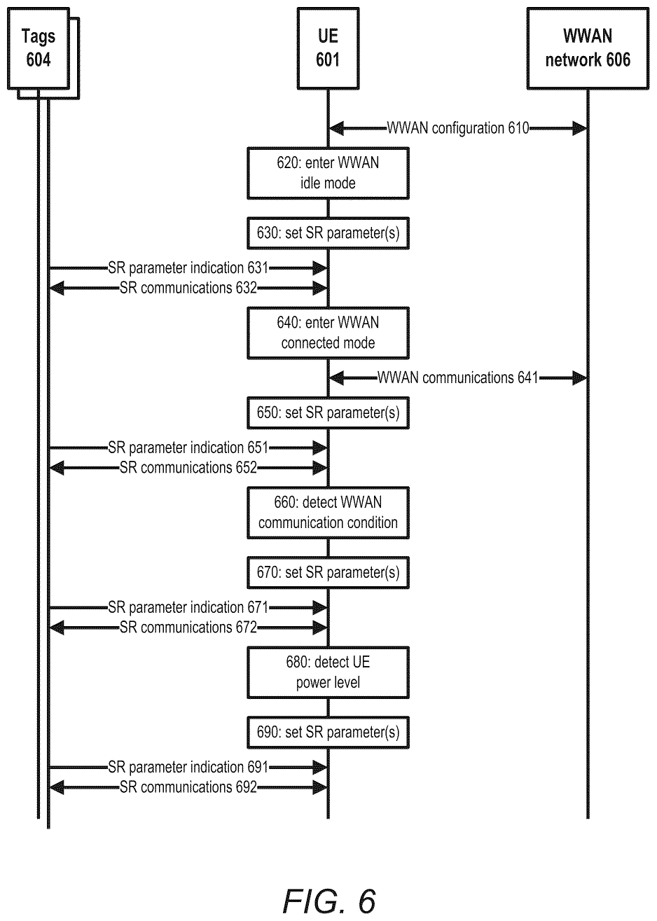

FIG. 6 illustrates a call flow in which a UE performs various WWAN operations and short-range (SR) communication, according to aspects of the disclosure. The call flow involves a UE 601 (which may correspond to any of the UEs described herein, including UE 104, UE 152, UE 164, UE 182, UE 190, UE 204, UE 302, RTR 304, RFID reader 401, etc.), one or more tags 604 (which may correspond to any of the tags and/or transponders described herein, including RFID tags 421, 422, 423, etc.), and a WWAN network 606 (which may correspond to any of the WWAN network components described herein, including base station 102, small cell base station 102′, access point 150, mmW base station 180, core network 170 or any component thereof, location server 172, location server 230, 5G core 210, NG-RAN 220, 5G core 260, core network 267, CU 280, DU 285, RU 287, etc.).

Some UEs support WWAN communication and RTR functionality (e.g., short-range (SR) communication). WWAN communication may refer to cellular networks (like 4G LTE, 5G NR, etc.) operating over large geographical areas, ensuring continuous connectivity for data transmission and communication. RTR technologies may refer to radio frequency identification (RFID), near-field communication (NFC), ultra-wideband (UWB), internet of things (IoT), Bluetooth low energy (BLE), wireless personal area network (WPAN), etc., where a user communicates with proximate devices. In some use cases, the user communicates with a large number of power-constrained devices. For example, in an RFID use case, SR communications may be used to obtain electronic product codes (EPCs) from a large number of passive or semi-passive transponders (e.g., devices that use received wireless energy to backscatter transmissions). This use case may involve tracking and managing of inventory, assets, and other items, which may be of particular use in logistics, retail, and industrial applications.

In FIG. 6, UE 601 receives a WWAN configuration 610 from WWAN network 606. The WWAN configuration 610 may configure the UE to communicate with WWAN network 606 and/or with other users via WWAN network 606. As part of the WWAN configuration 610 and/or various preconfigured characteristics of WWAN configuration 610, UE 601 may perform one or more WWAN operations. WWAN operations may involve transmission and/or reception of user data, transmission and/or reception of control signaling, etc. The WWAN operations may use transceivers configured to support WWAN communication (e.g., analogous to the one or more WWAN transceivers 310 illustrated in FIG. 3A). As will be discussed in greater detail below, WWAN operations may involve communication modes such as a connected mode and an idle mode. The connected mode may be associated with a higher level of UE activity than the idle mode. For example, in a connected mode, UE 601 may transmit and/or receive user data, and may transmit and/or receive all of the control signaling necessary to transmit and/or receive the user data. By contrast, in an idle mode, UE 601 may limit activities to those operations which might enable UE 601 to learn when it is necessary to return to the connected mode (e.g., monitoring for pages and monitoring neighbor devices). As an example, communication mode may refer to a radio resource control (RRC) state of the UE 601 (e.g., an RRC connected state, an RRC idle state, an RRC inactive state, etc.).

At block 620, UE 601 enters a WWAN idle mode. As noted above, the WWAN idle mode may refer to a low-activity state such as RRC idle state, in which WWAN operations are relatively limited. In a WWAN idle mode, UE 601 may transmit less (or not transmit at all), thereby consuming less power.

At block 630, UE 601 sets an SR parameter for SR communications. The SR communications may use transceivers configured to support SR communication (e.g., analogous to the one or more short-range device transceivers 350 and/or the one or more short-range device transceivers 360 illustrated in FIGS. 3A-3B). The setting at 630 may be based on the communication mode of UE 601. For example, after the entering at 620, UE 601 may be in the WWAN idle mode, and UE 601 may set the SR parameter based on UE 601 being in the WWAN idle mode.

The SR parameter may be Tari, as described above. Based on UE 601 being in the idle mode, UE 601 may set Tari to a value that is higher than it may otherwise be (e.g., if the UE were in a connected mode). For example, based on UE 601 being in the idle mode, UE 601 may set Tari to a highest possible value (e.g., 25 μs), a value that is higher than a lower possible value (e.g., greater than 6.25 μs), or higher than a previous Tari value (e.g., a value that is higher than a Tari value that was used before the entering at 620).

The SR parameter may be Miller index (M), as described above. Based on UE 601 being in the idle mode, UE 601 may set M to a value that is higher than it may otherwise be (e.g., if the UE were in a connected mode). For example, based on UE 601 being in the idle mode, UE 601 may set M to a highest possible value (e.g., 8), a value that is higher than a lower possible value (e.g., greater than 2), or higher than a previous M value (e.g., a value that is higher than an M value that was used before the entering at 620).

In some implementations, the setting at 630 may involve multiple SR parameters (e.g., both Tari and M) rather than a single SR parameter. In accordance with aspects of the disclosure, by setting Tari and/or M to high values based on UE 601 being in the idle mode, UE 601 may perform high-power SR operations (e.g., a long-range tag read operation with high reliability), and may do so at a time when resource demands associated with WWAN operations are low (WWAN idle mode). Moreover, since WWAN is idle, UE 601 can comply with specific absorption rate (SAR) requirements, even while performing high-power SR operations.

The UE 601 may transmit an SR parameter indication 631 to the one or more tags 604. The UE 601 and the one or more tags 604 may exchange SR communications 632 based on the SR parameter. For example, UE 601 may transmit one or more signals and/or commands to the one or more tags 604 using the SR parameter(s) set at 630. The one or more tags 604 may receive the one or more signal and/or commands based on the SR parameter(s) indicated by the SR parameter indication 631.

The UE 601 may indicate Tari using a preamble or frame-sync sequence. For example, a signal or command transmitted by UE 601 (e.g., select message 471, query message 472, acknowledgement message 482, query repeat message 484, etc.) may begin with a preamble or frame-sync sequence. The preamble or frame-sync sequence may indicate the value of Tari. For example, the preamble or frame-sync sequence may begin with a 12.5 μs delimiter, followed by a data-0 sequence having a duration that is equal to Tari, followed by a reader-tag calibration sequence (RTcal). The frame-sync sequence may end with the RTcal sequence, whereas the preamble may further include a tag-reader calibration sequence (TRcal). Upon receiving a signal or command that begins with the preamble or frame-sync sequence, a tag may be informed of the value of Tari. Accordingly, the SR parameter indication 631 may be a signal or command that begins with the preamble or frame-sync sequence.

The UE 601 may indicate M using explicit signaling. For example, a query message (e.g., query message 472) may comprise a field corresponding to M. The UE 601 may populate the M field with a specific M value (e.g., M=2, M=4, M=8, etc.). Upon receiving a signal or command that includes the M field, a tag may be informed of the value of M. Accordingly, the SR parameter indication 631 may be a signal or command that includes the M field.

The UE 601 and the one or more tags 604 may perform SR communications 632. The SR communications 632 may be based on the SR parameter(s) (e.g., the SR parameter(s) indicated by SR parameter indication 631). As noted above, the SR communications 632 may include, for example, a long-range, high-reliability tag read operation.

At block 640, UE 601 enters a WWAN connected mode. As noted above, the WWAN connected mode may refer to a high-activity state such as RRC connected state, in which WWAN operations are relatively extensive. In a WWAN connected mode, UE 601 may transmit prolifically, thereby consuming more power. The UE 601 and WWAN network 606 may perform WWAN communications 641 during the WWAN connected mode of the UE 601. The WWAN communications 641 may include transmission and/or reception of user data and/or control signaling. The WWAN communications 641 may include signaling related to positioning and/or sensing. The WWAN communications 641 may involve high-power transmissions by UE 601 (e.g., relative to WWAN idle mode, which include few transmissions or none at all).

At block 650, similar to block 630, UE 601 sets an SR parameter for SR communications, and the setting may be based on the communication mode of UE 601. For example, after the entering at 640, UE 601 may be in the WWAN connected mode, and UE 601 may set the SR parameter based on UE 601 being in the WWAN connected mode.

The SR parameter may be Tari, as described above. Based on UE 601 being in the connected mode, UE 601 may set Tari to a value that is lower than it may otherwise be (e.g., if the UE were in the idle mode). For example, based on UE 601 being in the connected mode, UE 601 may set Tari to a lowest possible value (e.g., 6.25 μs), a value that is lower than a highest possible value (e.g., lower than 25 μs), or lower than a previous Tari value (e.g., a value that is lower than a Tari value that was used before the entering at 640).

The SR parameter may be Miller index (M), as described above. Based on UE 601 being in the connected mode, UE 601 may set M to a value that is lower than it may otherwise be (e.g., if the UE were in the idle mode). For example, based on UE 601 being in the connected mode, UE 601 may set M to a lowest possible value (e.g., 2), a value that is lower than a highest possible value (e.g., less than 8), or lower than a previous M value (e.g., a value that is lower than an M value that was used before the entering at 640).

In some implementations, the setting at 650 may involve multiple SR parameters (e.g., both Tari and M) rather than a single SR parameter. In accordance with aspects of the disclosure, by setting Tari and/or M to low values based on UE 601 being in the connected mode, UE 601 may perform low-power SR operations at a time when resource demands associated with WWAN operations are high (WWAN connected mode). Moreover, since WWAN is in a connected mode, and possibly transmitting with high power, UE 601 can facilitate compliance with specific absorption rate (SAR) requirements by reducing transmission power associated with SR operations.

The UE 601 may transmit an SR parameter indication 651 to the one or more tags 604, and the UE 601 and one or more tags 604 may perform SR communications 652. The SR parameter indication 651 and SR communications 652 may be analogous to the SR parameter indication 631 and SR communications 632, respectively. For brevity, reiterative description is omitted.

At block 660, UE 601 detects a WWAN communication condition. At block 670, similar to block 630 and block 650, UE 601 sets an SR parameter for SR communications. The setting at 670 may be based on the WWAN communication condition detected at block 660.

The WWAN communication condition may be a pathloss condition. For example, as part of WWAN operations (e.g., as configured by WWAN configuration 610), UE 601 may measure a reference signal associated with the WWAN network 606 (e.g., transmitted by a base station associated with the 606). The measurement may indicate a pathloss from WWAN network 606 to UE 601. High pathloss may indicate that UE 601 is a long distance from WWAN network 606. Pathloss may also be affected by other factors, such as non-line-of-sight (NLOS) conditions (e.g., the presence of obstacles between UE 601 and WWAN network 606). To overcome high pathloss, UE 601 may increase transmission power (e.g., to successfully transmit uplink signaling to WWAN network 606). In accordance with aspects of the disclosure, the setting at 670 may be based on a pathloss of UE 601 being above a pathloss threshold.

The WWAN communication condition may be a transmission power condition. In some scenarios, UE 601 may transmit with high transmission power (e.g., to successfully transmit uplink signaling to WWAN network 606). For example, UE 601 may perform a pathloss measurement that indicates a high transmission power, and/or may receive a transmission power control (TPC) command indicating to increase transmission power. In accordance with aspects of the disclosure, the setting at 670 may be based on a transmission power of UE 601 being above a transmission power threshold.

The SR parameter may be Tari, as described above. Based on UE 601 detecting the WWAN communication condition (e.g., that the pathloss of UE 601 is above the pathloss threshold or that the transmission power of UE 601 is above the transmission power threshold), UE 601 may set Tari to a value that is lower than it may otherwise be (e.g., if the WWAN communication condition had not been detected). For example, based on UE 601 detecting the WWAN communication condition, UE 601 may set Tari to a lowest possible value (e.g., 6.25 μs), a value that is lower than a highest possible value (e.g., lower than 25 μs), or lower than a previous Tari value (e.g., a value that is lower than a Tari value that was used before the detecting at 660).

The SR parameter may be Miller index (M), as described above. Based on UE 601 detecting the WWAN communication condition (e.g., that the pathloss of UE 601 is above the pathloss threshold or that the transmission power of UE 601 is above the transmission power threshold), UE 601 may set M to a value that is lower than it may otherwise be (e.g., if the WWAN communication condition had not been detected). For example, based on UE 601 detecting the WWAN communication condition, UE 601 may set M to a lowest possible value (e.g., 2), a value that is lower than a highest possible value (e.g., less than 8), or lower than a previous M value (e.g., a value that is lower than an M value that was used before the detecting at 660).

In some implementations, the setting at 670 may involve multiple SR parameters (e.g., both Tari and M) rather than a single SR parameter. In accordance with aspects of the disclosure, by setting Tari and/or M to low values based on UE 601 detecting the WWAN communication condition, UE 601 may perform low-power SR operations at a time when resource demands associated with WWAN operations are high (e.g., to overcome high pathloss, to comply with TPC commands, etc.). For example, UE 601 can facilitate compliance with specific absorption rate (SAR) requirements by reducing transmission power associated with SR operations.

The UE 601 may transmit an SR parameter indication 671 to the one or more tags 604, and the UE 601 and one or more tags 604 may perform SR communications 672. The SR parameter indication 671 and SR communications 672 may be analogous to the SR parameter indication 631 and SR communications 632, respectively. For brevity, reiterative description is omitted.

At block 680, UE 601 detects a UE power level of UE 601. At block 690, similar to block 630 and block 650, UE 601 sets an SR parameter for SR communications. The setting at 690 may be based on the WWAN communication condition detected at block 680.

The UE power level may be a power level of a battery or other power supply associated with UE 601. In accordance with aspects of the disclosure, the setting at 670 may be based on the UE power level of UE 601 being below a power level threshold.

The SR parameter may be Tari, as described above. Based on UE 601 detecting the power level (e.g., that the power level of UE 601 is below the power level threshold), UE 601 may set Tari to a value that is lower than it may otherwise be (e.g., if the power level were not below the power level threshold). For example, based on UE 601 detecting that the power level is below the power level threshold, UE 601 may set Tari to a lowest possible value (e.g., 6.25 μs), a value that is lower than a highest possible value (e.g., lower than 25 μs), or lower than a previous Tari value (e.g., a value that is lower than a Tari value that was used before the detecting at 660).

The SR parameter may be Miller index (M), as described above. Based on UE 601 detecting the power level (e.g., that the power level of UE 601 is below the power level threshold), UE 601 may set M to a value that is lower than it may otherwise be (e.g., if the power level were not below the power level threshold). For example, based on UE 601 detecting that the power level is below the power level threshold, UE 601 may set M to a lowest possible value (e.g., 2), a value that is lower than a highest possible value (e.g., less than 8), or lower than a previous M value (e.g., a value that is lower than an M value that was used before the detecting at 660).

In some implementations, the setting at 670 may involve multiple SR parameters (e.g., both Tari and M) rather than a single SR parameter. In accordance with aspects of the disclosure, by setting Tari and/or M to low values based on UE 601 detecting that the power level is below the power level threshold, UE 601 may perform low-power SR operations at a time when power conservation is prioritized (e.g., when the battery level of UE 601 is low).

The UE 601 may transmit an SR parameter indication 691 to the one or more tags 604, and the UE 601 and one or more tags 604 may perform SR communications 692. The SR parameter indication 691 and SR communications 692 may be analogous to the SR parameter indication 631 and SR communications 632, respectively. For brevity, reiterative description is omitted.

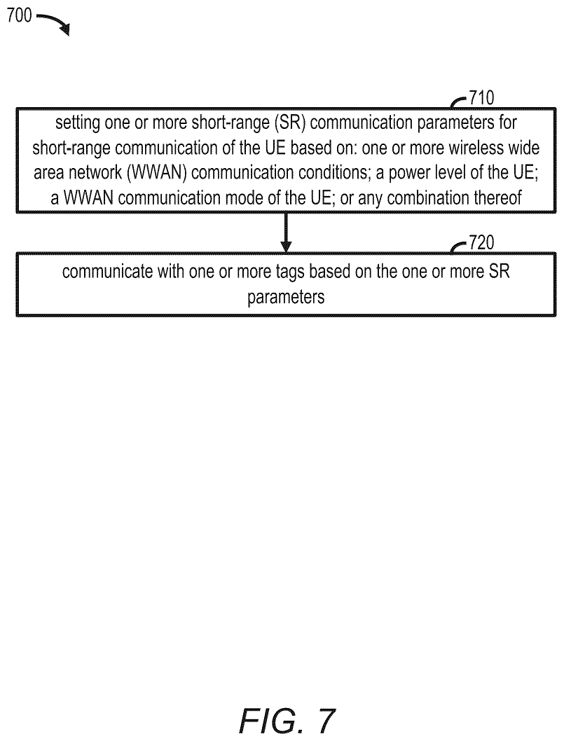

FIG. 7 illustrates an example method 700 of wireless communication, according to aspects of the disclosure. In an aspect, method 700 may be performed by a UE (e.g., any of the UEs described herein, including UE 104, UE 152, UE 164, UE 182, UE 190, UE 204, UE 302, RTR 304, RFID reader 401, UE 601, etc.).

At operation 710, the UE sets one or more short-range (SR) communication parameters for short-range communication of the UE based on: one or more wireless wide area network (WWAN) communication conditions; a power level of the UE; a WWAN communication mode of the UE; or any combination thereof.

In an aspect, operation 710 may be performed by the memory 340, the one or more processors 342, and/or the reading component 348, any or all of which may be considered means for performing this operation.

At operation 720, the UE communicates with one or more tags based on the one or more SR parameters.

In an aspect, operation 720 may be performed by the one or more WWAN transceivers 310, the one or more short-range wireless transceivers 320, the memory 340, the one or more processors 342, and/or the reading component 348, any or all of which may be considered means for performing this operation.

As will be appreciated, a technical advantage of the method 700 is that high-power SR operations may be performed at a time when resource demands associated with WWAN operations are low, and/or when resource availability at the UE is high. This may facilitate resource conservation and/or compliance with SAR requirements.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:
Clause 1. A method of wireless communication performed by a user equipment (UE), comprising: setting one or more short-range (SR) communication parameters for short-range communication of the UE based on: one or more wireless wide area network (WWAN) communication conditions; a power level of the UE; a WWAN communication mode of the UE; or any combination thereof; and communicating with one or more tags based on the one or more SR parameters.
Clause 2. The method of clause 1, wherein the one or more SR parameters: comprise a type A reference interval (TARI), a Miller index (M), or any combination thereof; have one or more possible values, the one or more possible values comprising a lowest value, a highest value, and at least one middle value between the lowest value and the highest value.
Clause 3. The method of clause 2, wherein: the one or more parameters comprise a type A reference interval (TARI); the lowest value of the TARI is 6.25 μs; the at least one middle value of the TARI is 12.5 μs; and the highest value of the TARI is 25 μs.
Clause 4. The method of any of clauses 2 to 3, wherein: the one or more parameters comprise a Miller index (M); the lowest value of M is 2; the at least one middle value of M is 4; and the highest value of M is 8.
Clause 5. The method of any of clauses 2 to 4, wherein the one or more WWAN communication conditions comprise a pathloss condition, and based on a pathloss of the UE being above a pathloss threshold: the one or more parameters are set to the lowest value; the one or more parameters are set to be lower than the highest value; the one or more parameters are set to be lower than a previous value of the one or more possible values; or any combination thereof.
Clause 6. The method of any of clauses 2 to 5, wherein the one or more WWAN communication conditions comprise a transmission power condition, and based on a transmission power of the UE being above a transmission power threshold: the one or more parameters are set to the lowest value; the one or more parameters are set to be lower than the highest value; the one or more parameters are set to be lower than a previous value of the one or more possible values; or any combination thereof.
Clause 7. The method of any of clauses 2 to 6, wherein based on the power level of the UE being below a power level threshold: the one or more parameters are set to the lowest value; the one or more parameters are set to be lower than the highest value; the one or more parameters are set to be lower than a previous value of the one or more possible values; or any combination thereof.
Clause 8. The method of any of clauses 2 to 7, wherein the WWAN communication mode is a connected mode, and based on the UE being in the connected mode: the one or more parameters are set to the lowest value; the one or more parameters are set to be lower than the highest value; the one or more parameters are set to be lower than a previous value of the one or more possible values; or any combination thereof.
Clause 9. The method of any of clauses 2 to 8, wherein the WWAN communication mode is an idle mode, and based on the UE being in the idle mode: the one or more parameters are set to the highest value; the one or more parameters are set to be higher than the lowest value; the one or more parameters are set to be higher than a previous value of the one or more possible values; or any combination thereof.
Clause 10. The method of any of clauses 1 to 9, further comprising transmitting, to the one or more tags, a query command comprising a field indicating an M value set by the UE.
Clause 11. The method of any of clauses 1 to 10, further comprising transmitting, to the one or more tags, a preamble or frame-sync, wherein a duration of the preamble or frame-sync indicates a TARI value set by the UE.
Clause 12. The method of any of clauses 1 to 11, wherein the one or more WWAN communication conditions and the WWAN communication mode are associated with one or more WWAN transceivers, and the short-range communication is via at least one short-range transceiver of the UE that is different from the one or more WWAN transceivers.
Clause 13. The method of any of clauses 1 to 12, wherein the one or more tags are radio frequency identification (RFID) tags, and the short-range communication comprises an RFID tag read operation.
Clause 14. A user equipment (UE) comprising: one or more memories; one or more transceivers; and one or more processors communicatively coupled to the one or more memories and the one or more transceivers, the one or more processors, either alone or in combination, configured to: set one or more short-range (SR) communication parameters for short-range communication of the UE based on: one or more wireless wide area network (WWAN) communication conditions; a power level of the UE; a WWAN communication mode of the UE; or any combination thereof; and communicate with one or more tags based on the one or more SR parameters.
Clause 15. The UE of clause 14, wherein the one or more SR parameters: comprise a type A reference interval (TARI), a Miller index (M), or any combination thereof; have one or more possible values, the one or more possible values comprising a lowest value, a highest value, and at least one middle value between the lowest value and the highest value.
Clause 16. The UE of clause 15, wherein: the one or more parameters comprise a type A reference interval (TARI); the lowest value of the TARI is 6.25 μs; the at least one middle value of the TARI is 12.5 μs; and the highest value of the TARI is 25 μs.
Clause 17. The UE of any of clauses 15 to 16, wherein: the one or more parameters comprise a Miller index (M); the lowest value of M is 2; the at least one middle value of M is 4; and the highest value of M is 8.
Clause 18. The UE of any of clauses 15 to 17, wherein the one or more WWAN communication conditions comprise a pathloss condition, and based on a pathloss of the UE being above a pathloss threshold: the one or more parameters are set to the lowest value; the one or more parameters are set to be lower than the highest value; the one or more parameters are set to be lower than a previous value of the one or more possible values; or any combination thereof.
Clause 19. The UE of any of clauses 15 to 18, wherein the one or more WWAN communication conditions comprise a transmission power condition, and based on a transmission power of the UE being above a transmission power threshold: the one or more parameters are set to the lowest value; the one or more parameters are set to be lower than the highest value; the one or more parameters are set to be lower than a previous value of the one or more possible values; or any combination thereof.
Clause 20. The UE of any of clauses 15 to 19, wherein based on the power level of the UE being below a power level threshold: the one or more parameters are set to the lowest value; the one or more parameters are set to be lower than the highest value; the one or more parameters are set to be lower than a previous value of the one or more possible values; or any combination thereof.
Clause 21. The UE of any of clauses 15 to 20, wherein the WWAN communication mode is a connected mode, and based on the UE being in the connected mode: the one or more parameters are set to the lowest value; the one or more parameters are set to be lower than the highest value; the one or more parameters are set to be lower than a previous value of the one or more possible values; or any combination thereof.
Clause 22. The UE of any of clauses 15 to 21, wherein the WWAN communication mode is an idle mode, and based on the UE being in the idle mode: the one or more parameters are set to the highest value; the one or more parameters are set to be higher than the lowest value; the one or more parameters are set to be higher than a previous value of the one or more possible values; or any combination thereof.
Clause 23. The UE of any of clauses 14 to 22, wherein the one or more processors, either alone or in combination, are further configured to transmit, via the one or more transceivers, to the one or more tags, a query command comprising a field indicating an M value set by the UE.
Clause 24. The UE of any of clauses 14 to 23, wherein the one or more processors, either alone or in combination, are further configured to transmit, via the one or more transceivers, to the one or more tags, a preamble or frame-sync, wherein a duration of the preamble or frame-sync indicates a TARI value set by the UE.
Clause 25. The UE of any of clauses 14 to 24, wherein the one or more WWAN communication conditions and the WWAN communication mode are associated with one or more WWAN transceivers, and the short-range communication is via at least one short-range transceiver of the UE that is different from the one or more WWAN transceivers.
Clause 26. The UE of any of clauses 14 to 25, wherein the one or more tags are radio frequency identification (RFID) tags, and the short-range communication comprises an RFID tag read operation.
Clause 27. A user equipment (UE) comprising: means for setting one or more short-range (SR) communication parameters for short-range communication of the UE based on: one or more wireless wide area network (WWAN) communication conditions; a power level of the UE; a WWAN communication mode of the UE; or any combination thereof; and means for communicating with one or more tags based on the one or more SR parameters.
Clause 28. The UE of clause 27, wherein the one or more SR parameters: comprise a type A reference interval (TARI), a Miller index (M), or any combination thereof; have one or more possible values, the one or more possible values comprising a lowest value, a highest value, and at least one middle value between the lowest value and the highest value.
Clause 29. The UE of clause 28, wherein: the one or more parameters comprise a type A reference interval (TARI); the lowest value of the TARI is 6.25 μs; the at least one middle value of the TARI is 12.5 μs; and the highest value of the TARI is 25 μs.
Clause 30. The UE of any of clauses 28 to 29, wherein: the one or more parameters comprise a Miller index (M); the lowest value of M is 2; the at least one middle value of M is 4; and the highest value of M is 8.
Clause 31. The UE of any of clauses 28 to 30, wherein the one or more WWAN communication conditions comprise a pathloss condition, and based on a pathloss of the UE being above a pathloss threshold: the one or more parameters are set to the lowest value; the one or more parameters are set to be lower than the highest value; the one or more parameters are set to be lower than a previous value of the one or more possible values; or any combination thereof.
Clause 32. The UE of any of clauses 28 to 31, wherein the one or more WWAN communication conditions comprise a transmission power condition, and based on a transmission power of the UE being above a transmission power threshold: the one or more parameters are set to the lowest value; the one or more parameters are set to be lower than the highest value; the one or more parameters are set to be lower than a previous value of the one or more possible values; or any combination thereof.
Clause 33. The UE of any of clauses 28 to 32, wherein based on the power level of the UE being below a power level threshold: the one or more parameters are set to the lowest value; the one or more parameters are set to be lower than the highest value; the one or more parameters are set to be lower than a previous value of the one or more possible values; or any combination thereof.
Clause 34. The UE of any of clauses 28 to 33, wherein the WWAN communication mode is a connected mode, and based on the UE being in the connected mode: the one or more parameters are set to the lowest value; the one or more parameters are set to be lower than the highest value; the one or more parameters are set to be lower than a previous value of the one or more possible values; or any combination thereof.
Clause 35. The UE of any of clauses 28 to 34, wherein the WWAN communication mode is an idle mode, and based on the UE being in the idle mode: the one or more parameters are set to the highest value; the one or more parameters are set to be higher than the lowest value; the one or more parameters are set to be higher than a previous value of the one or more possible values; or any combination thereof.
Clause 36. The UE of any of clauses 27 to 35, further comprising means for transmitting, to the one or more tags, a query command comprising a field indicating an M value set by the UE.
Clause 37. The UE of any of clauses 27 to 36, further comprising means for transmitting, to the one or more tags, a preamble or frame-sync, wherein a duration of the preamble or frame-sync indicates a TARI value set by the UE.
Clause 38. The UE of any of clauses 27 to 37, wherein the one or more WWAN communication conditions and the WWAN communication mode are associated with one or more WWAN transceivers, and the short-range communication is via at least one short-range transceiver of the UE that is different from the one or more WWAN transceivers.
Clause 39. The UE of any of clauses 27 to 38, wherein the one or more tags are radio frequency identification (RFID) tags, and the short-range communication comprises an RFID tag read operation.
Clause 40. A non-transitory computer-readable medium storing computer-executable instructions that, when executed by a user equipment (UE), cause the UE to: set one or more short-range (SR) communication parameters for short-range communication of the UE based on: one or more wireless wide area network (WWAN) communication conditions; a power level of the UE; a WWAN communication mode of the UE; or any combination thereof; and communicate with one or more tags based on the one or more SR parameters.
Clause 41. The non-transitory computer-readable medium of clause 40, wherein the one or more SR parameters: comprise a type A reference interval (TARI), a Miller index (M), or any combination thereof; have one or more possible values, the one or more possible values comprising a lowest value, a highest value, and at least one middle value between the lowest value and the highest value.
Clause 42. The non-transitory computer-readable medium of clause 41, wherein: the one or more parameters comprise a type A reference interval (TARI); the lowest value of the TARI is 6.25 μs; the at least one middle value of the TARI is 12.5 μs; and the highest value of the TARI is 25 μs.
Clause 43. The non-transitory computer-readable medium of any of clauses 41 to 42, wherein: the one or more parameters comprise a Miller index (M); the lowest value of M is 2; the at least one middle value of M is 4; and the highest value of M is 8.
Clause 44. The non-transitory computer-readable medium of any of clauses 41 to 43, wherein the one or more WWAN communication conditions comprise a pathloss condition, and based on a pathloss of the UE being above a pathloss threshold: the one or more parameters are set to the lowest value; the one or more parameters are set to be lower than the highest value; the one or more parameters are set to be lower than a previous value of the one or more possible values; or any combination thereof.
Clause 45. The non-transitory computer-readable medium of any of clauses 41 to 44, wherein the one or more WWAN communication conditions comprise a transmission power condition, and based on a transmission power of the UE being above a transmission power threshold: the one or more parameters are set to the lowest value; the one or more parameters are set to be lower than the highest value; the one or more parameters are set to be lower than a previous value of the one or more possible values; or any combination thereof.
Clause 46. The non-transitory computer-readable medium of any of clauses 41 to 45, wherein based on the power level of the UE being below a power level threshold: the one or more parameters are set to the lowest value; the one or more parameters are set to be lower than the highest value; the one or more parameters are set to be lower than a previous value of the one or more possible values; or any combination thereof.
Clause 47. The non-transitory computer-readable medium of any of clauses 41 to 46, wherein the WWAN communication mode is a connected mode, and based on the UE being in the connected mode: the one or more parameters are set to the lowest value; the one or more parameters are set to be lower than the highest value; the one or more parameters are set to be lower than a previous value of the one or more possible values; or any combination thereof.
Clause 48. The non-transitory computer-readable medium of any of clauses 41 to 47, wherein the WWAN communication mode is an idle mode, and based on the UE being in the idle mode: the one or more parameters are set to the highest value; the one or more parameters are set to be higher than the lowest value; the one or more parameters are set to be higher than a previous value of the one or more possible values; or any combination thereof.
Clause 49. The non-transitory computer-readable medium of any of clauses 40 to 48, further comprising computer-executable instructions that, when executed by the UE, cause the UE to transmit, to the one or more tags, a query command comprising a field indicating an M value set by the UE.
Clause 50. The non-transitory computer-readable medium of any of clauses 40 to 49, further comprising computer-executable instructions that, when executed by the UE, cause the UE to transmit, to the one or more tags, a preamble or frame-sync, wherein a duration of the preamble or frame-sync indicates a TARI value set by the UE.
Clause 51. The non-transitory computer-readable medium of any of clauses 40 to 50, wherein the one or more WWAN communication conditions and the WWAN communication mode are associated with one or more WWAN transceivers, and the short-range communication is via at least one short-range transceiver of the UE that is different from the one or more WWAN transceivers.
Clause 52. The non-transitory computer-readable medium of any of clauses 40 to 51, wherein the one or more tags are radio frequency identification (RFID) tags, and the short-range communication comprises an RFID tag read operation.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A user equipment (UE) comprising:
one or more memories;
one or more transceivers; and
one or more processors communicatively coupled to the one or more memories and the one or more transceivers, the one or more processors, either alone or in combination, configured to:
set one or more short-range (SR) communication parameters for short-range communication of the UE based on:
one or more wireless wide area network (WWAN) communication conditions;
a power level of the UE;
a WWAN communication mode of the UE; or
any combination thereof; and
communicate with one or more tags based on the one or more SR parameters.

2. The UE of claim 1, wherein the one or more SR parameters:
comprise a type A reference interval (TARI), a Miller index (M), or any combination thereof; and
have one or more possible values, the one or more possible values comprising a lowest value, a highest value, and at least one middle value between the lowest value and the highest value.

3. The UE of claim 2, wherein:
the one or more parameters comprise a type A reference interval (TARI);
the lowest value of the TARI is 6.25 μs;
the at least one middle value of the TARI is 12.5 μs; and
the highest value of the TARI is 25 μs.

4. The UE of claim 2, wherein:
the one or more parameters comprise a Miller index (M);
the lowest value of M is 2;
the at least one middle value of M is 4; and
the highest value of M is 8.

5. The UE of claim 2, wherein the one or more WWAN communication conditions comprise a pathloss condition, and based on a pathloss of the UE being above a pathloss threshold:
the one or more parameters are set to the lowest value;
the one or more parameters are set to be lower than the highest value;
the one or more parameters are set to be lower than a previous value of the one or more possible values; or
any combination thereof.

6. The UE of claim 2, wherein the one or more WWAN communication conditions comprise a transmission power condition, and based on a transmission power of the UE being above a transmission power threshold:
the one or more parameters are set to the lowest value;
the one or more parameters are set to be lower than the highest value;
the one or more parameters are set to be lower than a previous value of the one or more possible values; or
any combination thereof.

7. The UE of claim 2, wherein based on the power level of the UE being below a power level threshold:
the one or more parameters are set to the lowest value;
the one or more parameters are set to be lower than the highest value;
the one or more parameters are set to be lower than a previous value of the one or more possible values; or
any combination thereof.

8. The UE of claim 2, wherein the WWAN communication mode is a connected mode, and based on the UE being in the connected mode:
the one or more parameters are set to the lowest value;
the one or more parameters are set to be lower than the highest value;
the one or more parameters are set to be lower than a previous value of the one or more possible values; or
any combination thereof.

9. The UE of claim 2, wherein the WWAN communication mode is an idle mode, and based on the UE being in the idle mode:
the one or more parameters are set to the highest value;
the one or more parameters are set to be higher than the lowest value;
the one or more parameters are set to be higher than a previous value of the one or more possible values; or
any combination thereof.

10. The UE of claim 1, wherein the one or more processors, either alone or in combination, are further configured to transmit, via the one or more transceivers, to the one or more tags, a query command comprising a field indicating an M value set by the UE.

11. The UE of claim 1, wherein the one or more processors, either alone or in combination, are further configured to transmit, via the one or more transceivers, to the one or more tags, a preamble or frame-sync, wherein a duration of the preamble or frame-sync indicates a TARI value set by the UE.

12. The UE of claim 1, wherein the one or more WWAN communication conditions and the WWAN communication mode are associated with one or more WWAN transceivers, and the short-range communication is via at least one short-range transceiver of the UE that is different from the one or more WWAN transceivers.

13. The UE of claim 1, wherein the one or more tags are radio frequency identification (RFID) tags, and the short-range communication comprises an RFID tag read operation.

14. A method of wireless communication performed by a user equipment (UE), comprising:
setting one or more short-range (SR) communication parameters for short-range communication of the UE based on:
one or more wireless wide area network (WWAN) communication conditions;
a power level of the UE;
a WWAN communication mode of the UE; or
any combination thereof; and
communicating with one or more tags based on the one or more SR parameters.

15. The method of claim 14, wherein the one or more SR parameters:
comprise a type A reference interval (TARI), a Miller index (M), or any combination thereof; and
have one or more possible values, the one or more possible values comprising a lowest value, a highest value, and at least one middle value between the lowest value and the highest value.

16. The method of claim 15, wherein:
the one or more parameters comprise a type A reference interval (TARI);
the lowest value of the TARI is 6.25 μs;
the at least one middle value of the TARI is 12.5 μs; and
the highest value of the TARI is 25 μs.

17. The method of claim 15, wherein:
the one or more parameters comprise a Miller index (M);
the lowest value of M is 2;
the at least one middle value of M is 4; and
the highest value of M is 8.

18. A user equipment (UE) comprising:
means for setting one or more short-range (SR) communication parameters for short-range communication of the UE based on:
one or more wireless wide area network (WWAN) communication conditions;
a power level of the UE;
a WWAN communication mode of the UE; or
any combination thereof; and
means for communicating with one or more tags based on the one or more SR parameters.

19. The UE of claim 18, wherein the one or more SR parameters:
comprise a type A reference interval (TARI), a Miller index (M), or any combination thereof; and
have one or more possible values, the one or more possible values comprising a lowest value, a highest value, and at least one middle value between the lowest value and the highest value.

20. The UE of claim 19, wherein:
the one or more parameters comprise a type A reference interval (TARI);
the lowest value of the TARI is 6.25 μs;
the at least one middle value of the TARI is 12.5 μs; and
the highest value of the TARI is 25 μs.
